(19) United States
(12) Patent Application Publication
(10) Pub. No.: US 2025/0026325 A1
(43) Pub. Date: Jan. 23, 2025

(54) INVERSE TYRE MODEL ADAPTATION BASED ON TYRE THREAD DEFLECTION SENSOR OUTPUT DATA

(71) Applicant: VOLVO TRUCK CORPORATION, Göteborg (SE)

(72) Inventors: Mats RYDSTRÖM, Billdal (SE); Leo LAINE, Härryda (SE); Leon HENDERSON, Härryda (SE)

(73) Assignee: VOLVO TRUCK CORPORATION, Göteborg (SE)

(21) Appl. No.: 18/714,882

(22) PCT Filed: Dec. 1, 2021
(86) PCT No.: PCT/EP2021/083800

§ 371 Date: May 30, 2024

(51) Int. Cl. B60T 8/172

(52) U.S. Cl. CPC B60T 8/1725; B60T 2270/86

(57) ABSTRACT

A control unit for controlling a heavy-duty vehicle is arranged to obtain an initial inverse tire model configured to represent a preliminary relationship between wheel slip and generated longitudinal wheel force for at least one wheel of the heavy-duty vehicle. The control unit obtains data from a tire thread deflection sensor configured to measure an amount of tire thread deflection associated with the at least one wheel, and an amount of wheel slip of the at least one wheel corresponding to the amount of tire thread deflection. The control unit updates the obtained initial inverse tire model based on the amount of tire thread deflection and on the corresponding amount of wheel slip. The control unit controls the heavy-duty vehicle by configuring a target wheel speed or a target wheel slip of the at least one wheel based on the updated inverse tire model to generate a target longitudinal wheel force.

### TECHNICAL FIELD

The present disclosure relates to vehicle motion management for heavy-duty vehicles, i.e., coordinated control of motion support devices such as service brakes and propulsion devices.

The invention can be applied in heavy-duty vehicles such as trucks, buses, and construction machines. Although the invention will be described mainly with respect to cargo transport vehicles such as semi-trailer vehicles and trucks, the invention is not restricted to this particular type of vehicle but may also be used in other types of vehicles such as cars.

### BACKGROUND

Vehicles are becoming ever more complex in terms of mechanics, pneumatics, hydraulics, electronics, and software. A modern heavy-duty vehicle may comprise a wide range of different physical devices, such as combustion engines, electric machines, friction brakes, regenerative brakes, shock absorbers, air bellows, and power steering pumps. These physical devices are commonly known as Motion Support Devices (MSD). The MSDs may be individually controllable, for instance such that friction brakes may be applied at one wheel, i.e., a negative torque, while another wheel on the vehicle, perhaps even on the same wheel axle, is simultaneously used to generate a positive torque by means of an electric machine.

A commonly applied approach to controlling the different MSDs on a heavy-duty vehicle is to use torque control at the actuator level. However, this approach is not without performance limitations, and may not be very effective, e.g., if road surface friction rapidly changes. Improved control of heavy-duty vehicles may be realized by instead controlling wheel slip directly based on an inverse tyre model which maps a desired wheel force to a target wheel slip, which can then be accurately maintained in a responsive manner at the actuator level. This type of approach is described in, e.g., WO2021144010 A1. A similar control strategy controls wheel speed relative to vehicle speed over ground, which is essentially the same approach as controlling wheel slip.

A wheel slip-based MSD control system is of course somewhat dependent on the inverse tyre model used to translate between wheel force and wheel slip. There is a need for methods to determine this inverse tyre model in an accurate and robust manner.

### SUMMARY

It is an object of the present disclosure to provide control units and methods which facilitate vehicle control based on wheel slip or wheel speed requests instead of the customary torque requests, which speed or slip requests are obtained based on improved tyre behavioral models. This object is at least in part obtained by a control unit for controlling a heavy-duty vehicle. The control unit is arranged to obtain an initial inverse tyre model configured to represent a preliminary relationship between wheel slip and generated longitudinal wheel force for at least one wheel of the heavy-duty vehicle. The control unit is also arranged to obtain data from a tyre thread deflection sensor configured to measure an amount of tyre thread deflection associated with the at least one wheel, and an amount of wheel slip of the at least one wheel corresponding to the amount of tyre thread deflection. The control unit is arranged to update the initial inverse tyre model based on the amount of tyre thread deflection and on the corresponding amount of wheel slip to obtain a more accurate inverse tyre model which better models current wheel behavior. The control unit may furthermore be arranged to control the heavy-duty vehicle by configuring a target wheel speed or a target wheel slip of the at least one wheel based on the updated inverse tyre model to generate a target longitudinal wheel force in order to obtain a desired motion by the vehicle.

This way the control unit can obtain an inverse tyre model which is repeatedly updated in dependence of a current operating condition of the wheel, which then better models the actual behavior of the wheel in terms of the relationship between generated wheel force and wheel slip compared to if a fixed inverse tyre model would have been used. The inverse tyre model obtained in this manner is based on measurements of the actual operating conditions of the wheel, indicated via the tyre thread deflection data from the tyre thread deflection sensor, which is an advantage.

The tyre thread deflection sensor provides input data from which an actual generated wheel force can be inferred, at least indirectly by application of suitable signal processing techniques as will be discussed in the following. This means that both wheel force and the corresponding wheel slip is available to the control unit, which allows updating the inverse tyre model to better reflect actual wheel behavior on a near real-time basis. For instance, the control unit may periodically increase wheel slip gradually from a low value to a high value, and monitor tyre thread deflection in response to the wheel slip sweep. The data obtained in this manner can then be used to update the inverse tyre model to better reflect current wheel behavior.

The herein disclosed methods are applicable for positive acceleration (propulsion) as well as for negative acceleration (retardation, i.e., braking).

Instead of requesting torques from the different actuators as is customary, wheel slip requests or wheel speed requests determined relative to the speed of the vehicle are sent to the wheel torque actuators at wheel end, which are then tasked with maintaining operation at the requested wheel slip. This way the control of the MSDs is moved closer to wheel end, where a higher bandwidth control is possible due to the reduced control loop latencies and faster processing which is often available closer to wheel end. This control is made more accurate by the updated inverse tyre model, which better models the current behavior of the wheel. Compared to legacy torque-based control, this approach to MSD control improves both startability of heavy-duty vehicles, and also maneuvering in higher speed driving scenarios. For instance, if a wheel temporarily leaves the ground or experiences significantly reduced vertical force due to a bump in the road, the wheel will not spin out of control. Rather, the MSD control will quickly reduce applied torque to maintain wheel slip at the requested value, such that when the wheel again touches ground, the proper wheel speed will be maintained. The update to the inverse tyre model is preferably performed at lower bandwidth compared to the actual wheel slip control, which means that the impact to the inverse tyre model by, e.g., a wheel temporarily leaving the ground will not be significant.

The tyre thread deflection sensor may, e.g., comprise a flex sensor arrangement and/or a proximity sensor arrangement configured to measure a distance between a distal end of the tyre thread and a tyre base. Both these sensor types may be connected to the control unit, at least indirectly, via wireless link. The flex sensor arrangement comprises a flex sensor embedded into the tyre thread to directly measure how the tyre thread bends when interacting with the road surface, while the distance-based sensor instead measures how a distal end of the tyre thread moves in relation to a reference location on the wheel, with essentially the same effect. The amount of tyre thread deflection is related to the amount of generated longitudinal wheel force. Thus, generated wheel force can be estimated based on the output from the tyre thread deflection sensor. The estimation can be based on classical filtering techniques, such as a Kalman filter, or more advanced machine learning techniques where a model of generated tyre force has been training a-priori to recognize the output data coming from the tyre thread deflection sensor, and potentially also data coming from other sources.

According to aspects, the control unit is arranged to obtain data related to a tyre thread stiffness of the wheel and to determine an amount of generated longitudinal force of the at least one wheel based on the tyre thread stiffness of the wheel and on the measured amount of tyre thread deflection. The tyre thread stiffness may be obtained as part of a tyre model comprising data associated with the tyre, such as its material composition, dimension, thread geometry, and so on. The tyre model may also comprise a mapping from thread deflection to generated tyre force which has been determined, e.g., by the tyre manufacturer, beforehand and stored in memory. Slightly more advanced tyre models may of course also be envisioned. Machine learning techniques may also be configured to determine the relationship between wheel slip and wheel force based on tyre thread deflection data. Such machine learning techniques are trained using known generated forces and for known wheel slips.

According to aspects, the control unit is arranged to obtain a sequence of tyre thread deflection measurements associated with the at least one wheel, and a corresponding sequence of wheel slip amounts, and to update the obtained initial inverse tyre model based on the sequences. By processing sequences of data points instead of single data points, filtering techniques can be applied in order to suppress measurement noise and other forms of distortion. This results in a more accurate inverse tyre model, albeit at some delay. However, this delay may not be so detrimental to performance, since the actual low latency requirement vehicle control is based on wheel slip using the most current inverse tyre model, where small errors in the model may be tolerated.

According to aspects, the inverse tyre model is also configured to provide a remaining lateral force capacity of the wheel in addition to modelling the relationship between wheel slip and generated wheel force. This allows the control unit to reduce longitudinal wheel slip in case there is a concurrent need for lateral force. The remaining lateral force capacity can also be used to adjust bounds on the requests being sent to wheel end or as feedback to a control allocator to adapt its control requests to increase lateral force capacity of the wheel if it becomes too low for the current driving scenario.

According to aspects, the inverse tyre model is configured to provide a gradient of the desired wheel force with respect to wheel speed or wheel slip at a tyre operating point associated with the desired wheel force and the current operating condition of the wheel. This gradient allows the control unit to predict consequences of a change in wheel slip, which can be used in applications such as stability control and the like.

According to aspects, the current operating condition comprises a minimum required lateral force of the wheel. This means that it becomes possible to require operation with a minimum lateral force generation capability of a given wheel. For instance, if the vehicle is turning, a certain amount of lateral force may need to be generated in order to successfully complete the turn. With a requirement on lateral force, the wheel speed may need to be limited to wheel slips below the requested wheel slip. Similarly, the current operating condition optionally comprises a maximum allowed lateral slip angle of the wheel. With minimum required lateral force and maximum allowed lateral slip angle, the longitudinal slip request generated is limited to a search space where a minimum lateral force capacity is guaranteed using a maximum allowed lateral slip angle. Although both are optional arguments, they can be advantageously used to request longitudinal force in a safe manner that does not cause issues with, e.g., yaw instability and the like. The minimum required lateral force parameter can be used by a vehicle controller to ensure that enough lateral force capacity remains to be able to negotiate a given path having a certain acceleration profile and a curvature profile. The maximum longitudinal velocity of a vehicle throughout a maneuver is normally limited by roll stability and road friction. To know what range of lateral accelerations that can be supported by a vehicle unit negotiating a turning maneuver, the lateral force capability may be necessary to know. Thus, being able to specify a minimum required lateral force capability is an advantage.

The maximum allowed lateral slip angle can be used by the vehicle controller to ensure that the yaw moment balance or the side-slip of the vehicle is maintained at acceptable levels in agreement with the maneuver to be executed. This feature can be of particular benefit in autonomous or functional safety critical applications where it is desired to keep the tyres operating in their linear combined-slip range and therefore preventing any traction control or yaw stability interventions which may cause effects that are difficult to predict.

According to aspects, the inverse tyre model is configured to provide a gradient of the desired wheel force with respect to wheel speed or wheel slip at a tyre operating point associated with the desired wheel force and the current operating condition of the wheel. This output can be used to, e.g., custom tune the gains to the speed controller in the actuator depending on the priority of the control allocator. For instance, if the vehicle is cornering and the lateral gradient value is high, it indicates that poor speed control performance can degrade the lateral cornering performance and hence the gains for the speed controller can be adapted to mitigate this problem. Knowing the gradients can also help in performing analysis on stability and control robustness, which is an advantage.

According to aspects, the control unit is arranged to store a set of pre-determined inverse tyre models in memory, wherein the inverse tyre models are stored in the memory as a function of the current operating condition of the wheel. This means that the control unit has access to a range of different models, and it can select a suitable model from the range of models, advantageously based on the output from the tyre thread deflection sensor.

According to aspects, the control unit is furthermore arranged to further refine the inverse tyre model based on a measured wheel behavior and/or vehicle behavior in response to the control of the heavy duty vehicle based on the equivalent wheel speed or wheel slip, in addition to the data obtained from the tyre thread deflection sensor. Thus, advantageously, the control unit monitors the actual response by the wheel, and possibly also by the vehicle, and adjusts the inverse tyre model accordingly. This means that the control method becomes less sensitive to assumptions made on the performance of the vehicle in different scenarios or the impact of different parameters on the controllability of the vehicle. Also, if the operating conditions change in an unexpected manner, the inverse tyre model will adapt to the change, thereby providing robust control also in scenarios which have not yet been encountered.

According to aspects, the inverse tyre model is adjusted to always lie within pre-determined upper and/or lower limits on wheel force in dependence of wheel slip or wheel speed. This means that model adjustment of the inverse tyre model is allowed, but only within some predetermined boundaries. The boundary or boundaries therefore represent a safe-guard against unforeseen error in the model adaptation process. One example of an adaptive inverse tyre model is an artificial neural network which is continuously or at least regularly trained based on control input and actual wheel response or vehicle response to the control input.

The object is also obtained by a control unit for determining an inverse tyre model configured to represent a current relationship between wheel slip and generated longitudinal wheel force for a wheel on a heavy-duty vehicle. The control unit is arranged to obtain an initial inverse tyre model configured to represent a default relationship between wheel slip and generated longitudinal wheel force for the wheel, wherein the control unit is arranged to obtain data from a tyre thread deflection sensor configured to measure an amount of tyre thread deflection associated with the at least one wheel, and an amount of wheel slip of the at least one wheel corresponding to the amount of tyre thread deflection, wherein the control unit is arranged to update the initial inverse tyre model based on the amount of tyre thread deflection and on the corresponding amount of wheel slip. Thus, the herein proposed techniques can be used to determine an accurate inverse tyre model independently of the vehicle motion management control.

There is also disclosed herein computer programs, computer readable media, computer program products, and vehicles associated with the above discussed advantages.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

With reference to the appended drawings, below follows a more detailed description of embodiments of the invention cited as examples. In the drawings:

FIG. 1 shows an example heavy-duty vehicle;

FIG. 2 schematically illustrates a motion support device arrangement;

FIG. 3 illustrates a layered vehicle control function architecture;

FIG. 4 is a graph showing tyre force as function of wheel slip;

FIG. 5 illustrates adaptation of a wheel behavioral model to measurement data;

FIGS. 6A-B show example tyre thread deflections;

FIGS. 7A-B illustrate example tyre thread deflection sensors;

FIG. 8 shows an example motion support device control system;

FIG. 9 is a flow chart illustrating a method;

FIG. 10 schematically illustrates a control unit; and

FIG. 11 shows an example computer program product.

### DETAILED DESCRIPTION OF EXAMPLE EMBODIMENTS OF THE INVENTION

The invention will now be described more fully hereinafter with reference to the accompanying drawings, in which certain aspects of the invention are shown. This invention may, however, be embodied in many different forms and should not be construed as limited to the embodiments and aspects set forth herein; rather, these embodiments are provided by way of example so that this disclosure will be thorough and complete, and will fully convey the scope of the invention to those skilled in the art. Like numbers refer to like elements throughout the description.

It is to be understood that the present invention is not limited to the embodiments described herein and illustrated in the drawings; rather, the skilled person will recognize that many changes and modifications may be made within the scope of the appended claims.

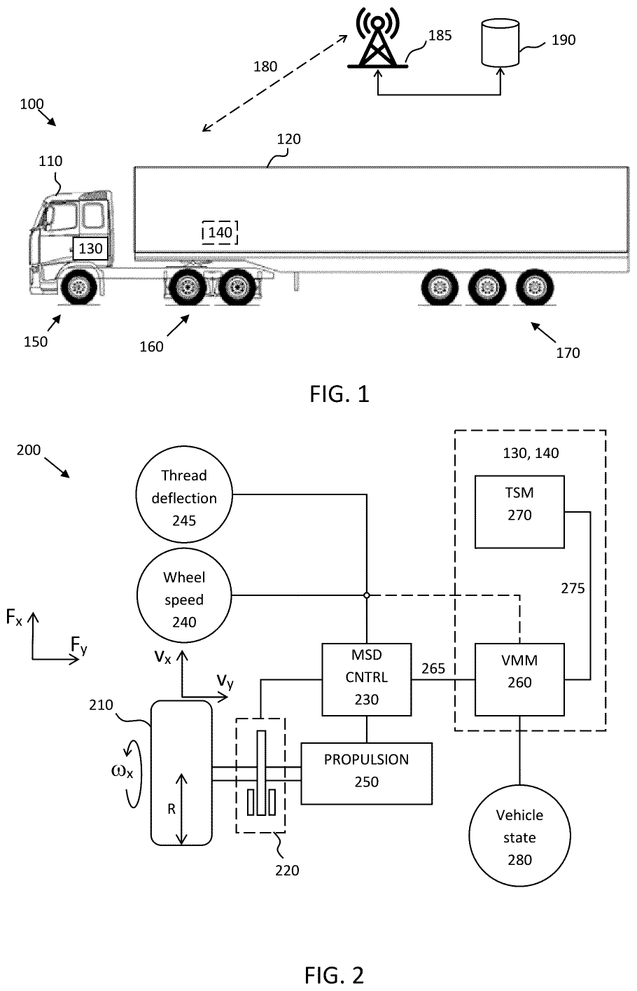

FIG. 1 illustrates an example vehicle 100 for cargo transport where the herein disclosed techniques can be applied with advantage. The vehicle 100 comprises a tractor or towing vehicle 110 supported on front wheels 150 and rear wheels 160, at least some of which are driven wheels. Normally but not necessarily, all the wheels on the tractor are braked wheels. The tractor 110 is configured to tow a first trailer unit 120 supported on trailer wheels 170 by a fifth wheel connection in a known manner. The trailer wheels are normally braked wheels but may also comprise driven wheels on one or more axles.

It is appreciated that the herein disclosed methods and control units can be applied with advantage also in other types of heavy-duty vehicles, such as rigid trucks, trucks with drawbar connections, construction equipment, buses, and the like.

The tractor 110 comprises a vehicle unit computer (VUC) 130 for controlling various kinds of functionality, i.a. to achieve propulsion, braking, and steering. Some trailer units 120 also comprise a VUC 140 for controlling various functions of the trailer, such as braking of trailer wheels, and sometimes also trailer wheel propulsion. The VUCs 130, 140 may be centralized or distributed over several processing circuits. Parts of the vehicle control functions may also be executed remotely, e.g., on a remote server 190 connected to the vehicle 100 via wireless link 180 and a wireless access network 185.

The VUC 130 on the tractor 110 (and possibly also the VUC 140 on the trailer 120) may be configured to execute vehicle control methods which are organized according to a layered functional architecture where some functionality may be comprised in a traffic situation management (TSM) domain in a higher layer and some other functionality may be comprised in a vehicle motion management (VMM) domain residing in a lower functional layer.

FIG. 2 schematically illustrates functionality 200 for controlling a wheel 210 by some example MSDs here comprising a friction brake 220 (such as a disc brake or a drum brake) and a propulsion device 250. The friction brake 220 and the propulsion device are examples of wheel torque generating devices, which may also be referred to as actuators and which can be controlled by one or more motion support device control units 230. The control is based on, e.g., measurement data obtained from a wheel speed sensor 240 and from other vehicle state sensors 280, such as radar sensors, lidar sensors, and also vision based sensors such as camera sensors and infra-red detectors. Other example torque generating motion support devices which may be controlled according to the principles discussed herein comprise engine retarders and power steering devices. An MSD control unit 230 may be arranged to control one or more actuators. For instance, it is not uncommon that an MSD control unit 230 is arranged to control both wheels on an axle.

The TSM function 270 plans driving operation with a time horizon of, e.g., 10 seconds or so. This time frame corresponds to, e.g., the time it takes for the vehicle 100 to negotiate a curve. The vehicle maneuvers, planned and executed by the TSM, can be associated with acceleration profiles and curvature profiles which describe a desired vehicle velocity and turning for a given maneuver. The TSM continuously requests 275 the desired acceleration profiles a_{req} and curvature profiles C_{req} from the VMM function 260 which performs force allocation to meet the requests from the TSM in a safe and robust manner. The VMM function 260 continuously feeds back capability information to the TSM function 270 detailing the current capability of the vehicle in terms of, e.g., forces, maximum velocities, and accelerations which can be generated.

Acceleration profiles and curvature profiles may also be obtained from a driver of the heavy-duty vehicle via normal control input devices such as a steering wheel, accelerator pedal and brake pedal. The source of said acceleration profiles and curvature profiles is not within scope of the present disclosure and will therefore not be discussed in more detail herein.

The interface 265 between VMM and MSDs capable of delivering torque to the vehicle's wheels has, traditionally, been focused on torque based requests to each MSD from the VMM without any consideration towards wheel slip. However, this approach has significant performance limitations. In case a safety critical or excessive slip situation arises, then a relevant safety function (traction control, anti-lock brakes, etc.) operated on a separate control unit normally steps in and requests a torque override in order to bring the slip back into control. The problem with this approach is that since the primary control of the actuator and the slip control of the actuator are allocated to different electronic control units (ECUs), the latencies involved in the communication between them significantly limits the slip control performance. Moreover, the related actuator and slip assumptions made in the two ECUs that are used to achieve the actual slip control can be inconsistent and this in tum can lead to sub-optimal performance.

Longitudinal wheel slip λ may, in accordance with SAE J670 (SAE Vehicle Dynamics Standards Committee Jan. 24, 2008) be defined as

$$λ = \frac{R {ω}_{x} - {v}_{x}}{max ( \vert R ω \vert , \vert {v}_{x} \vert}$$

where R is an effective wheel radius in meters, ωₓ is the angular velocity of the wheel, and Vₓ is the longitudinal speed of the wheel (in the coordinate system of the wheel). Thus, λ is bounded between −1 and 1 and quantifies how much the wheel is slipping with respect to the road surface. Wheel slip is, in essence, a speed difference measured between the wheel and the vehicle. Thus, the herein disclosed techniques can be adapted for use with any type of wheel slip definition. It is also appreciated that a wheel slip value is equivalent to a wheel speed value given a velocity of the wheel over the surface, in the coordinate system of the wheel.

In order for a wheel (or tyre) to produce a wheel force, slip must occur. For smaller slip values the relationship between slip and generated force are approximately linear, where the proportionality constant is often denoted as the slip stiffness of the tyre. A tyre on a wheel 210 is subject to a longitudinal force Fx, a lateral force Fy, and a normal force Fz. The normal force Fz is key to determining some important vehicle properties. For instance, the normal force to a large extent determines the achievable lateral tyre force F_{y} by the wheel since, normally, F_{y}≤μF_{z}, where μ is a friction coefficient associated with a road friction condition. The maximum available lateral force for a given lateral slip can be described by the so-called Magic Formula as described in “Tyre and vehicle dynamics”, Elsevier Ltd. 2012, ISBN 978-0-08-097016-5, by Hans Pacejka.

Significant benefits can be achieved by instead using a wheel speed or wheel slip based request on the interface 265 between VMM and the MSD controller or controllers 230, thereby shifting the difficult actuator speed control loop to the MSD controllers, which generally operate with a much shorter sample time compared to that of the VMM function. Such an architecture can provide much better disturbance rejection compared to a torque based control interface and thus improves the predictability of the forces generated at the tyre road contact patch.

The VMM 260 and optionally also the MSD control unit 230 maintains information on vₓ (in the reference frame of the wheel), while a wheel speed sensor 240 or the like can be used to determine ωₓ (the rotational velocity of the wheel).

An important part of the present disclosure is the thread deflection sensor arrangement 245 shown in FIG. 2. This sensor arrangement is configured to measure tyre thread deflection during vehicle operation, i.e., to provide output data indicative of a current amount of thread deflection at one or more of the wheels 210 of the heavy-duty vehicle 100. This data can be used to estimate how much longitudinal force that is being generated at the wheel 210 at a given point in time. By comparing the deflection data with wheel speed or wheel slip data obtained at the same time, a relationship between wheel force and wheel slip can be inferred, as will be discussed in more detail below. Some example tyre thread deflection sensors will be discussed below in connection to FIG. 7A and FIG. 7B.

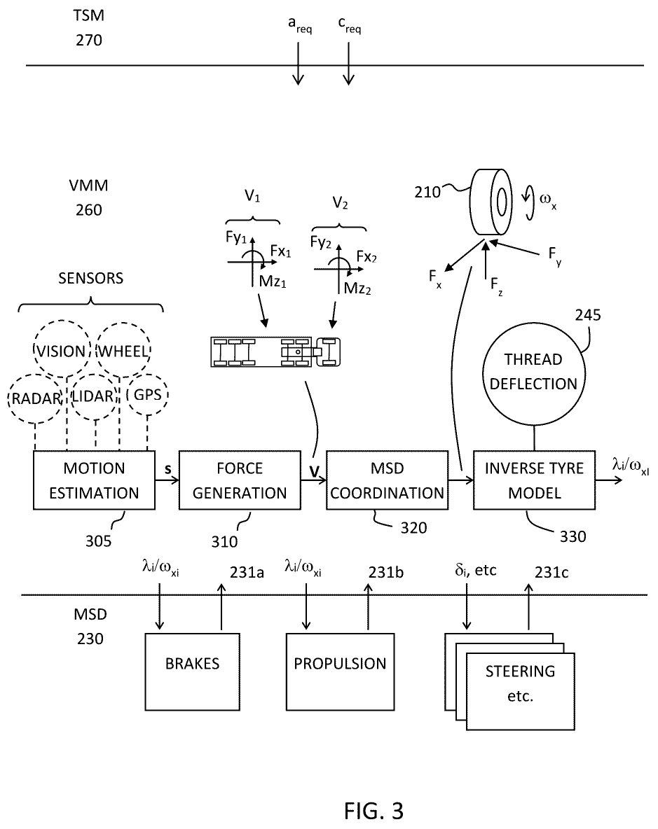

With reference also to FIG. 3, the VMM function 260 operates with a time horizon of about 1 second or so, and continuously transforms the acceleration profiles areq and curvature profiles C_{req} into control commands for controlling vehicle motion functions, actuated by the different MSDs 220, 250 of the vehicle 100 which report back capabilities to the VMM, which in turn are used as constraints in the vehicle control. The VMM function 260 performs vehicle state or motion estimation 305, i.e., the VMM function 260 continuously determines a vehicle state s comprising positions, speeds, accelerations and articulation angles of the different units in the vehicle combination by monitoring operations using various sensors 306 arranged on the vehicle 100, often but not always in connection to the MSDs 220, 250.

The result of the motion estimation 305, i.e., the estimated vehicle state s, is input to a force generation module 310 which determines the required global forces V=[V₁, V₂] for the different vehicle units to cause the vehicle 100 to move according to the requested acceleration and curvature profiles a_{req}, c_{req}. The required global force vector V is input to an MSD coordination function 320 which allocates wheel forces and coordinates other MSDs such as steering and suspension. The coordinated MSDs then together provide the desired lateral Fy and longitudinal Fx forces on the vehicle units, as well as the required moments Mz, to obtain the desired motion by the vehicle combination 100.

By determining vehicle unit motion using sensors 306 such as, e.g., global positioning systems, vision-based sensors, wheel speed sensors, radar sensors and/or lidar sensors, and translating this vehicle unit motion into a local coordinate system of a given wheel 210 (in terms of, e.g., longitudinal and lateral velocity components), it becomes possible to accurately estimate wheel slip in real time by comparing the vehicle unit motion in the wheel reference coordinate system to data obtained from the wheel speed sensor 240 arranged in connection to the wheel 210.

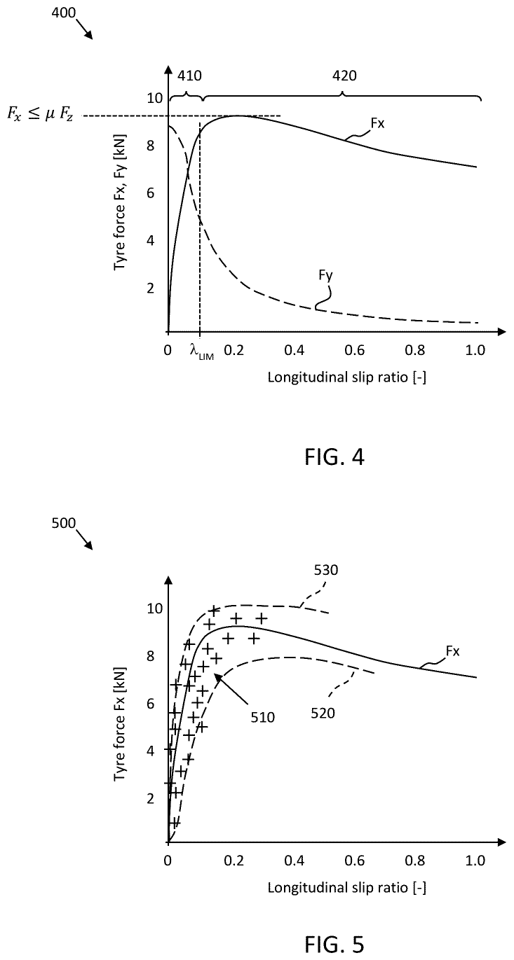

A tyre model, referred to herein as an inverse tyre model, which will be discussed in more detail in connection to FIG. 4 below, can as mentioned above be used to translate between a desired longitudinal tyre force Fx; for a given wheel i and an equivalent wheel slip λᵢ for the wheel. Herein, an inverse tyre model is a model of wheel behavior which describes wheel force generated in longitudinal direction (in the rolling direction) and/or lateral direction (orthogonal to the longitudinal direction) as function of wheel slip. In “Tyre and vehicle dynamics”, Elsevier Ltd. 2012, ISBN 978-0-08-097016-5, Hans Pacejka covers the fundamentals of tyre models. See, e.g., chapter 7 where the relationship between wheel slip and longitudinal force is discussed.

To summarize, the VMM function 260 manages both force generation and MSD coordination, i.e., it determines what forces that are required at the vehicle units in order to fulfil the requests from the TSM function 270, for instance to accelerate the vehicle according to a requested acceleration profile requested by TSM and/or to generate a certain curvature motion by the vehicle also requested by TSM. The forces may comprise e.g., yaw moments Mz, longitudinal forces Fx and lateral forces Fy, as well as different types of torques to be applied at different wheels.

With reference to FIG. 3, the inverse tyre model block 330 translates the required wheel forces Fxᵢ, Fyᵢ determined for each wheel, or for a subset of wheels, by the MSD coordination block 320 into equivalent wheel speeds ω_{wi} or wheel slips λᵢ. These wheel speeds or slips are then sent to the respective MSD controllers 230. The MSD controllers report back capabilities 231a-231c which can be used as constraints in, e.g., the MSD coordination block 320.

FIG. 4 is a graph showing an example of achievable tyre force as function of wheel slip. The longitudinal tyre force Fx shows an almost linearly increasing part 410 for small wheel slips, followed by a part 420 with more non-linear behaviour for larger wheel slips. The obtainable lateral tyre force Fy decreases rapidly even at relatively small longitudinal wheel slips. It is desirable to maintain vehicle operation in the linear region 410, where the obtainable longitudinal force in response to an applied brake command is easier to predict, and where enough lateral tyre force can be generated if needed. To ensure operation in this region, a wheel slip limit λ_{LIM} on the order of, e.g., 0.1, can be imposed on a given wheel.

For larger wheel slips, e.g., exceeding 0.1, a more non-linear region 420 is seen. Control of a vehicle in this region may be difficult and is therefore often avoided. It may be interesting for traction in off-road conditions and the like where a larger slip limit for traction control might be preferred, but not for on-road operation.

This type of tyre model can be used by the VMM 260 to generate a desired tyre force at some wheel. Instead of requesting a torque corresponding to the desired tyre force, the VMM can translate the desired tyre force into an equivalent wheel slip (or, equivalently, a wheel speed relative to a speed over ground) and request this slip instead. The main advantage being that the MSD control device 230 will be able to deliver the requested torque with much higher bandwidth by maintaining operation at the desired wheel slip, using the vehicle speed vₓ and the wheel rotational velocity ωₓ.

The inverse tyre model may be implemented at least partly as an adaptive model configured to automatically or at least semi-automatically adapt to the current operating conditions of the vehicle. This can be achieved by repeatedly monitoring (continuously or periodically) the wheel force generated in response to a given wheel slip request, which can be achieved by means of the herein disclosed tyre thread deflection sensors 245. The adaptive inverse tyre model can then be adjusted to more accurately model the wheel forces obtained in response to a given wheel slip request from a wheel.

FIG. 5 is a graph 500 illustrating an inverse tyre model which maps longitudinal tyre force Fx to wheel slip. Measurements 510 of pairs (F, λ) of wheel slip with corresponding tyre force F are also plotted, which measurements have at least in part been obtained from data output by a tyre thread deflection sensor 245.

In a first example of the adaptation of the inverse tyre model, sample pairs (F, λ) of generated force F vs current wheel slip λ are repeatedly obtained, where the force values F are obtained at least indirectly from the output of the tyre thread deflection sensor 245 and the wheel slip values are determined based on the difference between wheel speed and vehicle speed as discussed above. The inverse tyre model is then continuously or periodically updated to fit the current measurement results. For instance, a Kalman filter can be applied to track coefficients {cᵢ} of a polynomial model which can then be used as inverse tyre model. A polynomial fit can also be made to fit measurement data 510 to a model, which model can then be used as the inverse tyre model.

In a second example a neural network or other form of AI-based method is applied to continuously update the inverse tyre model. The network is trained, e.g., using the sample pairs (F,λ) of generated force F vs current wheel slip λ. Input to the network (in addition to tyre deflection data) can be, e.g., vehicle load, tyre specification, and road condition in terms of, e.g., friction. The output can be a set of coefficients for a polynomial model which can be used as a representation of the inverse tyre model.

According to some other aspects, the control units disclosed herein are arranged to further refine the inverse tyre model f⁻¹ based on an estimated wheel force generated in response to a control command for controlling motion of the heavy-duty vehicle 100.

Generally, the control unit 130, 140 may be arranged to obtain a sequence of tyre thread deflection measurements associated with the at least one wheel 210, and a corresponding sequence of wheel slip λ amounts, and to update the obtained initial inverse tyre model 400, 500 based on the sequences.

To summarize the discussion up until now, there has been disclosed a control unit 130, 140 for controlling a heavy-duty vehicle 100. The control unit 130, 140 is arranged to obtain an initial inverse tyre model f⁻¹,400, 500 configured to represent a preliminary relationship between wheel slip λ and generated longitudinal wheel force Fx for at least one wheel 210 of the heavy-duty vehicle 100. This initial inverse model may be a pre-configured model stored in memory, or the result of a previous update performed by the control unit 130, 140. The initial model may also be just an empty framework to be populated by model data. The control unit 130, 140 is arranged to obtain data from a tyre thread deflection sensor 245 configured to measure an amount of tyre thread deflection associated with the at least one wheel 210, and an amount of wheel slip λ of the at least one wheel 210 corresponding to the amount of tyre thread deflection. The combination of wheel slip data (obtained from wheel speed sensor output and data regarding the speed of the vehicle) with the output data from the tyre thread deflection sensor can be used to map wheel force to wheel slip, and vice versa. For instance, in an ideal example scenario, a vehicle starting from standstill and linearly increasing acceleration while monitoring tyre thread deflection would be able to map the relationship between wheel slip and generated wheel force in one go. However, the measurement data is perhaps most likely to be obtained in a more randomized manner, depending on the requests from the TSM function 270. It is expected that at least the linear region 410 will be covered eventually during normal vehicle operation. In case there is a lack of input data for some part of the inverse tyre model, then the VMM function 260 may generate a control command to cover the missing piece, e.g., by braking with some wheels and generating positive torque by some other wheels to fill the entire wheel slip region from −1 to 1, or at least from, say −0.8 to 0.8.

The control unit 130, 140 is arranged to update the obtained initial inverse tyre model 400, 500 based on the amount of tyre thread deflection and on the corresponding amount of wheel slip λ, and to control the heavy-duty vehicle 100 by configuring a target wheel speed ωₓ or a target wheel slip λ of the at least one wheel 210 based on the updated inverse tyre model 400, 500 to generate a target longitudinal wheel force Fx.

Another optional type of measurement which can be used to further refine the inverse tyre model in addition to the tyre deflection measurements is the resistance encountered by an electric machine when trying to generate a particular wheel speed. This “torque status” output signal of the electric machine can be directly translated into an equivalent wheel force via the effective wheel radius R. The wheel force samples can also be obtained from the VMM function as part of the force allocation process. For instance, if the VMM notes that a too small longitudinal force is consistently obtained in response to a given requested wheel slip, then the model can be adjusted to account for the discrepancy, e.g., by scaling it to better match the desired wheel forces. In this context, it is noted that the inverse tyre model need not be correct in an absolute frame of reference, i.e., that the inverse tyre model is able to exactly predict the generated force in Newton for a given wheel slip. Rather, it is enough if the inverse tyre model is such as to allow successful control of the vehicle by the VMM function 260. Interestingly, by adjusting the inverse tyre model in this manner based on measured wheel force in response to wheel slip requests, other characteristics of the vehicle will automatically be included in the modelling to more accurately represent the mapping between wheel slip and wheel force.

It is appreciated that this model adaptation does not need to be performed on-board the vehicle 100. Rather, measurement data can be uploaded to the remote server 190 which can be tasked with finding a suitable model for controlling the vehicle based on wheel slip instead of based on torque request. This model can then account for measurement data from more than one vehicle, perhaps from a set of vehicles of the same type, or operational design domain. The model or sets of models can then be fed back from the remote server 190 to the vehicle to be used in control of the vehicle 100.

The whole inverse tyre model f⁻¹ can of course also be realized as a neural network which is trained during different types of operating conditions. Then, as the operating conditions of the heavy-duty vehicle changes, the inverse tyre model also changes such that the corresponding wheel slip for a given wheel force changes over time, which is an advantage.

The inverse tyre model f⁻¹ can also be adjusted to always lie within pre-determined upper and lower limits on wheel force in dependence of wheel slip or wheel speed. These limits may, e.g., be obtained as statistical limits derived from the measurement data 510. For instance, the upper and lower limits 520, 530 may be set so as to limit the inverse tyre model within one or two stand deviations from the mean, or the like.

Safety margins can also be applied to the adaptation itself, i.e., a constrained adaptation can be performed where the inverse tyre model is not permitted to deviate outside of a fenced region around some nominal model curve. This fenced region can be pre-determined or adjusted in accordance with operating condition, or by pre-defined dynamic driving tasks (DDTs) on known operational design domains (ODDs) which will reduce the required amount of verification and validation.

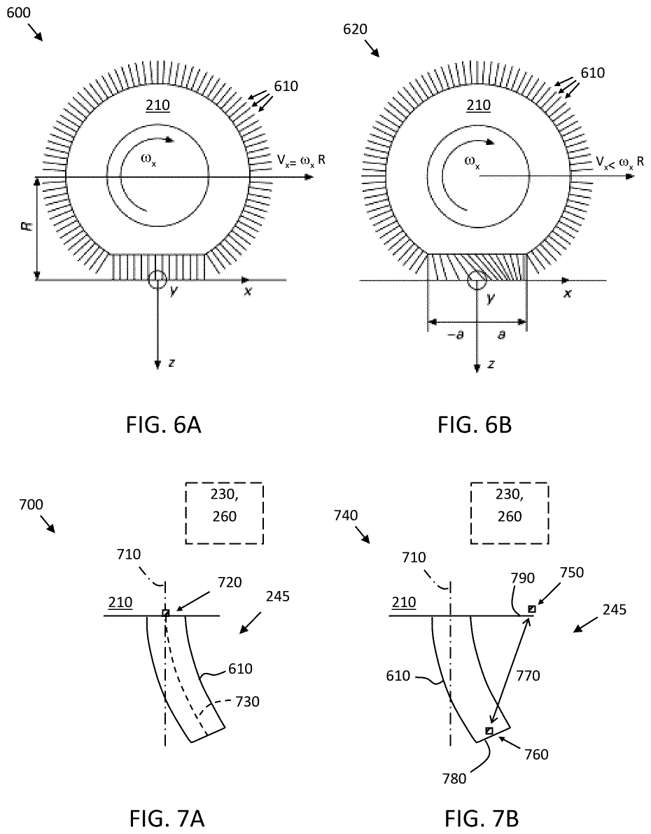

FIG. 6A and FIG. 6B illustrate two example tyre thread deformations 600, 620. The tyre 210 is here represented by a disk and the tyre thread 610 is modelled by a single row of flexible bristles along the circumference of the disk. Initially, a free-rolling tyre is assumed, so that the forward speed, Vx, at the center of the wheel equals the linear speed of rolling, ωₓ R. The wheel is rolling steadily, so by following the motion of a single bristle it is possible to obtain the motion of all bristles, as each bristle may be assumed to follow exactly the same path. This is a fundamental observation that allows the treatment of steady state force generation using the brush concept. A single representative bristle enters the contact patch at the leading edge. The bristle travels towards the negative x-axis until it reaches the trailing edge of the contact and finally exits. The bristle tip remains at the same global position, where it first met the road, the bristle remains completely vertical (undeformed) and the wheel rolls over the bristle while moving forward. As the single representative bristle moves backwards in the SAE frame, new bristles gradually enter the contact to cover up all previous positions of the representative bristle. Owing to the lack of bristle deformation in both lateral and longitudinal directions, no tyre forces are generated.

The situation 620 in FIG. 6B is now considered, where, owing to the application of a traction torque, the wheel 210 rotates faster than dictated by its instantaneous forward speed, Vx. Steady state operating conditions are assumed, so the difference between the forward speed and the linear speed of rolling is constant. A representative bristle enters the contact patch at the leading edge and the bristle tip sticks to the ground due to friction. The bristle base travels backwards with respect to the bristle tip. This relative motion produces an equal rate of deflection of the tyre thread. The longitudinal force generated by this deflection of the tyre thread can be determined or at least approximated if the deformation is multiplied by the stiffness of the bristle (or thread) and integrated along the contact patch:

$${F}_{x} = {K}_{x} {\int }_{- a}^{a} u dx$$

where Kₓ is the longitudinal stiffness of the bristles per unit length of the contact, (in (N/m)/m), and u is the deflection of the bristle. Kₓ is a property of the tyre, and can be pre-determined or estimated on-line during vehicle operation. The deformation u or some quantity correlated with u can be measured by the tyre thread deflection sensor 245. According to some aspects, the control unit 130, 140 is arranged to obtain data related to the tyre thread stiffness Kₓ of the wheel 210 and to determine an amount of generated longitudinal force Fx of the at least one wheel based on the tyre thread stiffness Kₓ of the wheel 210 and on the measured amount of tyre thread deflection.

It is preferred to use a plurality of tyre thread deflection sensors, arranged evenly spaced out around the tyre, although a single sensor may also be sufficient.

It is appreciated that the output from a tyre thread deflection sensor will be a sequence from an onset at a where the thread portion makes contact with the road surface until it leaves the road surface at −a, as shown in FIG. 6B. The onset and cessation of the tyre deflection sensor signal can be seen from the signal itself, hence it is not necessary to know the contact patch exactly.

Generally, a tyre thread deflection sensor arrangement 245 may be used to determine a currently generated wheel force Fx by one out of several methods.

According to a first example, the tyre thread deflection sensor arrangement comprises a control unit which is arranged to translate between the sensor signal and a wheel force. This translation may, e.g., be realized as a pre-determined mapping between different tyre thread deflection signature signals and corresponding wheel force. This mapping may be determined off-line under controlled circumstances, such as in a laboratory or in a workshop. The mapping may be in the form of a function or a look-up-table.

According to a second example, a machine learning structure can be trained to output a currently generated wheel force based on an input sensor signal from a tyre thread deflection sensor arrangement 245. The machine learning structure may, e.g., be a neural network. The machine learning structure can be trained under controlled circumstances where the currently generated wheel force is known.

According to a third example, analytical methods can be used to derive the generated wheel force based on a physical model of the tyre, such as the well-known brush model. Such models are generally known and will therefore not be discussed in more detail herein.

FIG. 7A and FIG. 7B show two example tyre thread deflection sensor arrangements 700, 740, by which the quantity u can be determined at least indirectly, i.e., by which the tyre thread deflection can be monitored. It is appreciated that both examples ideally only make measurements of tyre thread deflection for the part of the tyre which is in contact with the road surface.

The first example 700 comprises a flex sensor arrangement 720, 730. A flex sensor or bend sensor is a sensor that measures the amount of deflection or bending. The sensor may be embedded into the tyre thread, and the resistance of sensor element is varied by bending the sensor. Since the resistance is directly proportional to the amount of bend it is used as goniometer, and often called flexible potentiometer. The sensor arrangement may comprise a controller 720 connected to a sensor element 730 arranged to measure deflection about some reference axis 710 and report the measured deflection or a value associated with the deflection to a control unit, such as an MSD controller 230 or the VMM function 260. The link to and from the controller 720 is preferably a wireless link, such as a Bluetooth link or the like. The sensor itself or the control unit can be configured to translate the output of the sensor to an estimate of generated wheel force, as discussed above.

The second example 740 is a proximity sensor arrangement 750, 760 configured to measure a distance 770 between a distal end of the tyre thread 780 and a tyre base 790. This tyre thread deflection sensor is based on high accuracy distance measurement between a first measurement device 750 and a second measurement device 760, which continuously monitor the distance 770 therein between. The distance 770 or a value correlated with the distance 770 is then fed to an MSD controller 230 or directly to the VMM function 260 via wireless link. The first measurement device 750 may, e.g., be a radar transceiver and the second device some sort of radar reflector. Alternatively, the first and the second device may comprise radio transmitters arranged to determine the distance 770 by time of flight measurements. Generally, any type of proximity or distance sensor set-up may provide relevant measurement data. As for the example in FIG. 7A, the sensor itself or the control unit can be configured to translate the output of the sensor to an estimate of generated wheel force.

To summarize the overall idea discussed herein, there is disclosed a method and corresponding control unit/units for controlling a heavy-duty vehicle such as the vehicle 100 shown in FIG. 1. The method is based on wheel slip control rather than torque-based control, where a target wheel slip value is sent to a wheel end controller. The target wheel slip is selected based on a mapping between force and slip-the inverse tyre model, such that a desired wheel force is generated at the wheel. The relationship between wheel slip and wheel force is accurately known, at least in part since the relationship is refined based on the output of one or more tyre thread deflection sensors which continuously or at least periodically measure the deflection of the tyre threads as the vehicle moves over the road surface. This tyre thread deflection measured by the sensors can be translated into generated longitudinal wheel force, e.g., by the above described example methods. Thus, the data from the tyre thread deflection sensors is mapped to wheel force, which is associated with corresponding measurements of wheel slip, allowing refinement of the inverse tyre model.

The inverse tyre model can be further refined by addition of other forms of input data, such as torque data from a electric machine, thereby providing an even more accurate inverse tyre model.

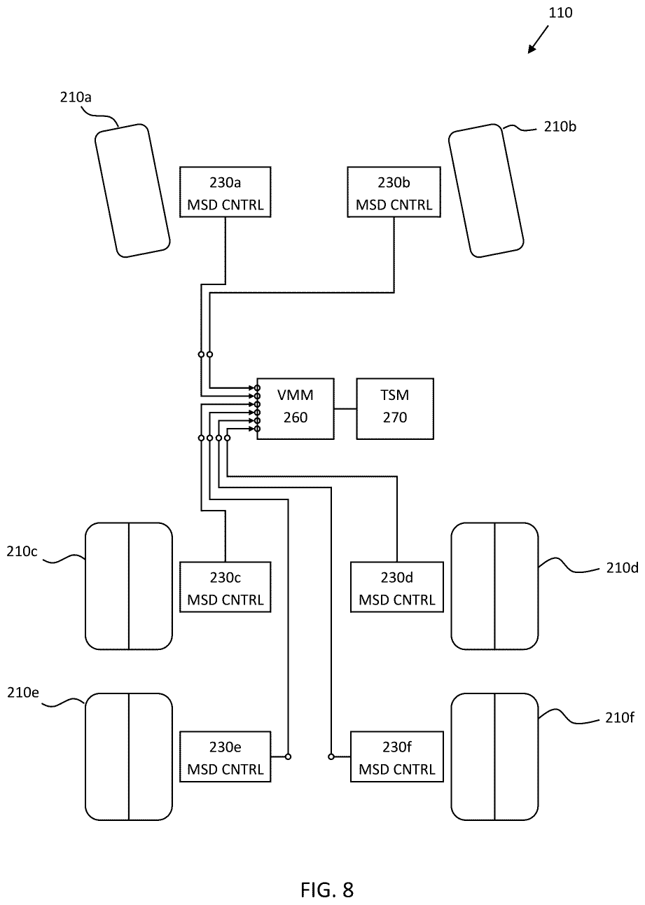

It is appreciated that the MSD control units discussed herein may also be configured to control one or more MSDs associated with other wheels, in addition to the wheel 210, such as MSDs for controlling wheels of a given axle, or the wheels on one side of a trailer unit, or all wheels of a trailer unit. A system of MSD control units 230a-230f arranged to control respective wheels 210a-210f based on control signals received from a central VMM unit 260 is schematically illustrated in FIG. 8. One or more additional vehicle units, such as one or more trailers 120, possibly connected via dolly vehicle units, can also be controlled in this manner. In this case there may be more than one VMM function, where one VMM function can be assigned a master role and other VMM functions can be configured to operate in slave mode.

The control unit 130, 140 is optionally arranged to obtain the inverse tyre model in dependence of a current operating condition of the wheel 210, and also arranged to control the heavy-duty vehicle 100 based on the equivalent wheel speed or wheel slip. This means that the control unit is configured to adapt the inverse tyre mode to the current operating conditions of the vehicle in some way. For instance, if the vehicle is loaded with heavy weight cargo, then the inverse tyre model used to control the vehicle is adjusted to account for the change in operating condition. Various types of operating condition parameters may be considered, as will be discussed in the following. By obtaining the inverse tyre model in dependence of current operating conditions, a more accurate control can be achieved, and also a more robust control. Thus, it is appreciated that the inverse tyre models considered herein are dynamic models which, different from constant models, are adapted to fit the current operating conditions of the heavy-duty vehicle. This improves both vehicle performance and safety.

The current operating condition may comprise a vehicle or wheel speed over ground vector with components vₓ, v_{y}. This vehicle speed over ground can be used to determine a wheel rotational velocity corresponding to a given amount of slip, e.g., by computing the normalized wheel slip difference discussed above. Some tyres also behave a bit differently depending on if the wheel is rotating slowly or faster. Thus, some inverse tyre models may exhibit differences over an operating speed range from, e.g., 0 km/h over ground to say 150 km/h. It is appreciated that wheel control based on requested wheel rotational velocities requires a relatively fast interface between VMM function 260 and the MSD control unit 230. This is because the wheel rotational velocity required to obtain a given wheel slip depends on the velocity over ground, which may change relatively fast over time.

The current operating condition optionally also comprises a normal load Fz or vertical tyre force associated with the wheel 210. The normal load may have a significant effect on the inverse tyre model, i.e., the mapping between desired wheel force and wheel speed or wheel slip. For instance, the maximum available longitudinal tyre force Fx is limited by the normal force and friction coefficient. Thus, by parameterizing the inverse tyre model based on normal load Fz, a more accurate inverse tyre model can be obtained which more closely models the current operating conditions of the vehicle 100.

According to some other aspects, the current operating condition comprises an estimated tyre stiffness Cest of the wheel 210. If the tyre stiffness is explicitly estimated, then a more accurate inverse tyre model can be obtained. The tyre stiffness may, e.g., be estimated based on a feedback system, where measurements of tyre force is mapped against wheel slip, and a linear or semi-linear relationship can be determined. The tyre stiffness can also be obtained, e.g., from a database maintained in the remote server 190 or in a memory connected to the VUC, which can be indexed if the tyre can be identified. Identifying a tyre attached to a given wheel can, e.g., be done by embedding a radio frequency identification (RFID) device into the tyre, or by manual configuration.

The current operating conditions may furthermore comprise an estimated tyre road friction coefficient μ of the wheel. This road friction can be estimated in real time using known methods, such as those disclosed in, e.g., U.S. Pat. Nos. 9,475,500 B2, 8,983,749 B1 or EP 1719676 B1. The inverse tyre model can then be adapted to match the current road friction. The current operating condition may furthermore comprise a minimum required lateral force capacity Fy,min and/or a maximum allowed lateral slip α of the wheel 210 of the wheel 210.

The minimum lateral force capacity Fy,min and maximum lateral slip angle limit α are optional constraints to the tyre model. If this data is taken as input to the inverse tyre model function, then the output can be determined with these parameters as constraints. For instance, it can be ascertained that output wheel speeds or wheel slips are not such as to generate an insufficient lateral force capability, or lateral slip, which is an advantage.

Conversely, the inverse tyre model f⁻¹ can also be configured to provide a remaining lateral force capacity Fy,rem of the wheel 210. The remaining lateral force capacity Fy,rem can be used to adjust bounds on the requests being sent or as feedback to the control allocator to adapt its control requests to increase remaining lateral force capacity if it becomes too low.

The inverse tyre model f⁻¹ can also be configured to provide a gradient of the desired wheel force dFx, dFy with respect to wheel speed or wheel slip at a tyre operating point associated with the desired wheel force and the current operating condition of the wheel 210. The gradient provides information about the behavior of the model if a small change in input parameters is made and can be used with advantage to adjust control algorithms in, e.g., the MSD control units 230. For instance, the gradients can be used to adjust a gain of a control function such as a PID controller.

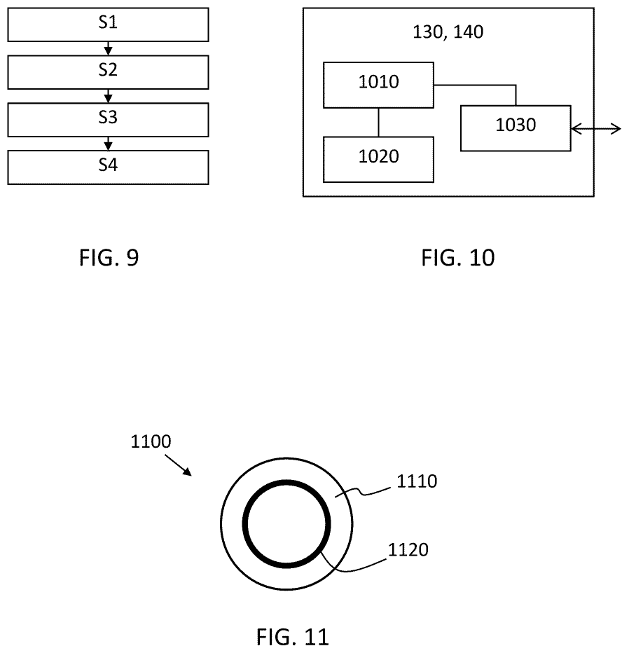

FIG. 9 is a flow chart illustrating methods which summarize at least some of the discussions above. There is illustrated a method performed in a control unit 130, 140 for controlling a heavy-duty vehicle 100. The method comprises
obtaining S1 an initial inverse tyre model f⁻¹,400, 500 configured to represent a relationship between wheel slip λ and generated longitudinal wheel force Fx for at least one wheel 210 of the heavy-duty vehicle 100,
obtaining S2 data from a tyre thread deflection sensor 245 configured to measure an amount of tyre thread deflection associated with the at least one wheel 210, and an amount of wheel slip λ of the at least one wheel 210 corresponding to the amount of tyre thread deflection,
updating S3 the obtained initial inverse tyre model 400, 500 based on the amount of tyre thread deflection and on the corresponding amount of wheel slip λ, and
controlling S4 the heavy-duty vehicle 100 by configuring a target wheel speed ωₓ or a target wheel slip λ of the at least one wheel 210 based on the updated inverse tyre model 400, 500 to generate a target longitudinal wheel force Fx.

FIG. 10 schematically illustrates, in terms of a number of functional units, the components of a control unit such as the VUC 130, 140. The control unit may implement one or more of the above discussed functions of the TSM 270, VMM 260 and/or the MSD control function 230, according to embodiments of the discussions herein. The control unit is configured to execute at least some of the functions discussed above for control of a heavy-duty vehicle 100. Processing circuitry 1010 is provided using any combination of one or more of a suitable central processing unit CPU, multiprocessor, microcontroller, digital signal processor DSP, etc., capable of executing software instructions stored in a computer program product, e.g. in the form of a storage medium 1020. The processing circuitry 1010 may further be provided as at least one application specific integrated circuit ASIC, or field programmable gate array FPGA.

Particularly, the processing circuitry 1010 is configured to cause the control unit 101 to perform a set of operations, or steps, such as the methods discussed in connection to FIG. 9. For example, the storage medium 1020 may store the set of operations, and the processing circuitry 1010 may be configured to retrieve the set of operations from the storage medium 1020 to cause the control unit 1100 to perform the set of operations. The set of operations may be provided as a set of executable instructions. Thus, the processing circuitry 1010 is thereby arranged to execute methods as herein disclosed.

The storage medium 1020 may also comprise persistent storage, which, for example, can be any single one or combination of magnetic memory, optical memory, solid state memory or even remotely mounted memory.

The control unit 1100 may further comprise an interface 1030 for communications with at least one external device. As such the interface 1030 may comprise one or more transmitters and receivers, comprising analogue and digital components and a suitable number of ports for wireline or wireless communication.

The processing circuitry 1010 controls the general operation of the control unit 1100, e.g., by sending data and control signals to the interface 1030 and the storage medium 1020, by receiving data and reports from the interface 1030, and by retrieving data and instructions from the storage medium 1020. Other components, as well as the related functionality, of the control node are omitted in order not to obscure the concepts presented herein.

According to an example, the processing circuitry in FIG. 10 may form part of a control unit 130, 140 for determining an inverse tyre model f⁻¹,400, 500 configured to represent a current relationship between wheel slip λ and generated longitudinal wheel force Fx for a wheel 210 on a heavy-duty vehicle 100, wherein the control unit 130, 140 is arranged to obtain an initial inverse tyre model f⁻¹,400, 500 configured to represent a default relationship between wheel slip λ and generated longitudinal wheel force Fx for the wheel 210, wherein the control unit 130, 140 is arranged to obtain data from a tyre thread deflection sensor 245 configured to measure an amount of tyre thread deflection associated with the at least one wheel 210, and an amount of wheel slip λ of the at least one wheel 210 corresponding to the amount of tyre thread deflection, wherein the control unit 130, 140 is arranged to update the initial inverse tyre model 400, 500 based on the amount of tyre thread deflection and on the corresponding amount of wheel slip λ.

FIG. 11 illustrates a computer readable medium 1110 carrying a computer program comprising program code means 1120 for performing the methods illustrated in FIG. 9, when said program product is run on a computer. The computer readable medium and the code means may together form a computer program product 1100.

1. A control unit for controlling a heavy-duty vehicle, wherein the control unit is arranged to obtain an initial inverse tire model configured to represent a preliminary relationship between wheel slip and generated longitudinal wheel force for at least one wheel of the heavy-duty vehicle,
wherein the control unit is arranged to obtain data from a tire thread deflection sensor configured to measure an amount of tire thread deflection associated with the at least one wheel and an amount of wheel slip of the at least one wheel corresponding to the amount of tire thread deflection,
wherein the control unit is arranged to update the obtained initial inverse tire model based on the amount of tire thread deflection and on the corresponding amount of wheel slip,
wherein the control unit is arranged to control the heavy-duty vehicle by configuring a target wheel speed or a target wheel slip of the at least one wheel based on the updated inverse tire model to generate a target longitudinal wheel force.

2. The control unit according to claim 1, arranged to obtain data related to a tire thread stiffness of the wheel and to determine an amount of generated longitudinal force of the at least one wheel based on the tire thread stiffness of the wheel and on the measured amount of tire thread deflection.

3. The control unit according to claim 1, arranged to obtain a sequence of tire thread deflection measurements associated with the at least one wheel, and a corresponding sequence of wheel slip amounts, and to update the obtained initial inverse tire model based on the sequences.

4. The control unit according to claim 1, wherein the tire thread deflection sensor comprises a flex sensor arrangement.

5. The control unit according to claim 1, wherein the tire thread deflection sensor comprises a proximity sensor arrangement configured to measure a distance between a distal end of the tire thread and a tire base.

6. The control unit according to claim 1, wherein the inverse tire model is configured to provide a remaining lateral force capacity of the wheel.

7. The control unit according to claim 1, wherein the inverse tire model is configured to provide a gradient of the desired wheel force with respect to wheel speed or wheel slip at a tire operating point associated with the desired wheel force and the current operating condition of the wheel.

8. The control unit according to claim 1, wherein the control unit is arranged to store a pre-determined inverse tire model in memory, wherein the inverse tire model is stored in the memory as a function of the current operating condition of the wheel.

9. The control unit according to claim 1, wherein the inverse tire model is adjusted to always lie within pre-determined upper and/or lower limits on wheel force in dependence of wheel slip or wheel speed.

10. The control unit according to claim 1, wherein the control unit is arranged to represent the inverse tire model as a look-up table.

11. The control unit according to claim 1, wherein the control unit is arranged to represent the inverse tire model as a neural network.

12. A vehicle comprising a control unit according to claim 1.

13. A method performed in a control unit for controlling a heavy-duty vehicle, the method comprising:
obtaining an initial inverse tire model configured to represent a relationship between wheel slip and generated longitudinal wheel force for at least one wheel of the heavy-duty vehicle,
obtaining data from a tire thread deflection sensor configured to measure an amount of tire thread deflection associated with the at least one wheel, and an amount of wheel slip of the at least one wheel corresponding to the amount of tire thread deflection,
updating the obtained initial inverse tire model based on the amount of tire thread deflection and on the corresponding amount of wheel slip, and
controlling the heavy-duty vehicle by configuring a target wheel speed or a target wheel slip of the at least one wheel based on the updated inverse tire model to generate a target longitudinal wheel force.

14. A computer program comprising program code means for performing the steps of claim 13 when said program is run on a computer or on processing circuitry of a control unit.

15. A computer readable medium carrying a computer program comprising program code for performing the steps of claim 13 when said program code is run on a computer or on processing circuitry of a control unit.

16. A control unit for determining an inverse tire model configured to represent a current relationship between wheel slip and generated longitudinal wheel force for a wheel on a heavy-duty vehicle
wherein the control unit is arranged to obtain an initial inverse tire model configured to represent a default relationship between wheel slip and generated longitudinal wheel force for the wheel,
wherein the control unit is arranged to obtain data from a tire thread deflection sensor configured to measure an amount of tire thread deflection associated with the at least one wheel, and an amount of wheel slip of the at least one wheel corresponding to the amount of tire thread deflection,
wherein the control unit is arranged to update the initial inverse tire model based on the amount of tire thread deflection and on the corresponding amount of wheel slip.
